(19) United States
(12) Patent Application Publication
(10) Pub. No.: US 2007/0067095 A1
(43) Pub. Date: Mar. 22, 2007

(54) Method and apparatus for resolving ambiguous waypoints

(75) Inventor: Jeremy R. King, Albuquerque, NM (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/173,673

(22) Filed: Jul. 1, 2005

(51) Int. Cl. G01C 21/00

(52) U.S. Cl. 701/206

(57) ABSTRACT

A system is used to determine which entry in the NDB should be chosen for similarly named identifiers. It first tries to use waypoints before the ambiguous name to determine which entry to use. If those are not available, the present system will use the aircraft's current position, or, if the aircraft is on the ground, the origin airport as determinative factors. These factors will take into account not having the aircraft's location, when the ambiguous waypoint is to be inserted into the route, and if the waypoint is an airway entry or exit.

### BACKGROUND OF THE INVENTION

1. Field of the Invention (Technical Field)

The present invention relates to aircraft flight management system (FMS) software and more particularly to a method and apparatus to determine which navigation database (NDB) entry, from a plurality of NDB entries, containing a similarly named waypoint, to use.

2. Background Art

The problem occurs in creating flight plans from uplinked datalink messages, where waypoint names occur one or more times in the NDB. For example, when a flight plan is transferred to an aircraft over a data connection (a datalink message), a waypoint is usually included in the flight plan by name only. If the aircraft has multiple entries in the NDB with the same name, there needs to be a set of rules used to determine which NDB entry should be used.

Presently, a prior art system called Pegasus FMS (created by Honeywell CAS) allows the pilot to manually resolve which of multiple waypoints they want by displaying all waypoints with the entered name, so the pilot can choose which one is desired. When a flight plan is uplinked via datalink, the pilot has no way to know which waypoint Air Traffic Control (ATC) intends to be used. When Pegasus processes an uplinked flight plan, it always uses the first match found in the Navigation Database.

This prior art manual selection takes time, and the operator might not select the desired NDB entry. An automatic selection of the first occurrence in the NDB might not select the desired waypoint. Selection of the wrong waypoint can inhibit some flight plan structures from being added (entry into an airway, for example). A wrong selection might include a waypoint very far away, often on the other side of the globe.

### SUMMARY OF THE INVENTION (DISCLOSURE OF THE INVENTION)

Disclosed is a method and apparatus for automatically selecting a correct waypoint from similarly identified waypoints based on selected criteria. Throughout this disclosure the terms waypoint and route are similarly defined. The present invention solves the problems described above by providing a predictable, specified method of choosing among multiple entries in the NDB. A specific NDB entry can be chosen by the present invention by including the waypoint name, and it's position (latitude and longitude), or the entry that will be chosen can be predicted using the specified method and apparatus.

When ambiguous route information items are encountered while processing a route uplink, the system shall select the item that matches the route in accordance with the following algorithm discarding those items that cannot be resolved: If the route information item is the first item and the aircraft is on the ground, choose the candidate that is closest to the departure airport; if the route information item is the first item and the aircraft is in the air, choose the candidate that is closest to the aircraft's current position; for each subsequent route information item that does not include an optional latitude/longitude, choose the candidate that is closest to the previous route information item; for each subsequent route information item that includes an optional latitude/longitude, choose the candidate that is closest to the optional latitude/longitude; if the route information item is following an airway and is not on that airway, discard the airway; and if the route information item precedes an airway and is not on that airway, discard the airway.

A primary object of the present invention is to provide automatic selection of an ambiguous waypoint, without the pilot having to select one each time a waypoint has multiple locations.

Another object of the present invention is to use the current flight plan to determine which ambiguous waypoint should be selected.

Yet another object of the present invention is to provide selection of an ambiguous waypoint closest to the aircraft when no flight plan is available to provide a reference.

A primary advantage of the present invention is that it provides deterministic flight plans, from a list of simple waypoint identifiers, without having to specify the position for each point. It requires less communication between the aircraft and the ground station to verify waypoint and flight plans. It also removes the occurrence of waypoints that are obviously incorrect, due to exceedingly large distance between one waypoint and those surrounding it.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1a is a flow chart showing the preferred embodiment of the present invention.

FIG. 1b is the continuation of the flow chart of FIG. 1a.

### DESCRIPTION OF THE PREFERRED EMBODIMENTS (BEST MODES FOR CARRYING OUT THE INVENTION)

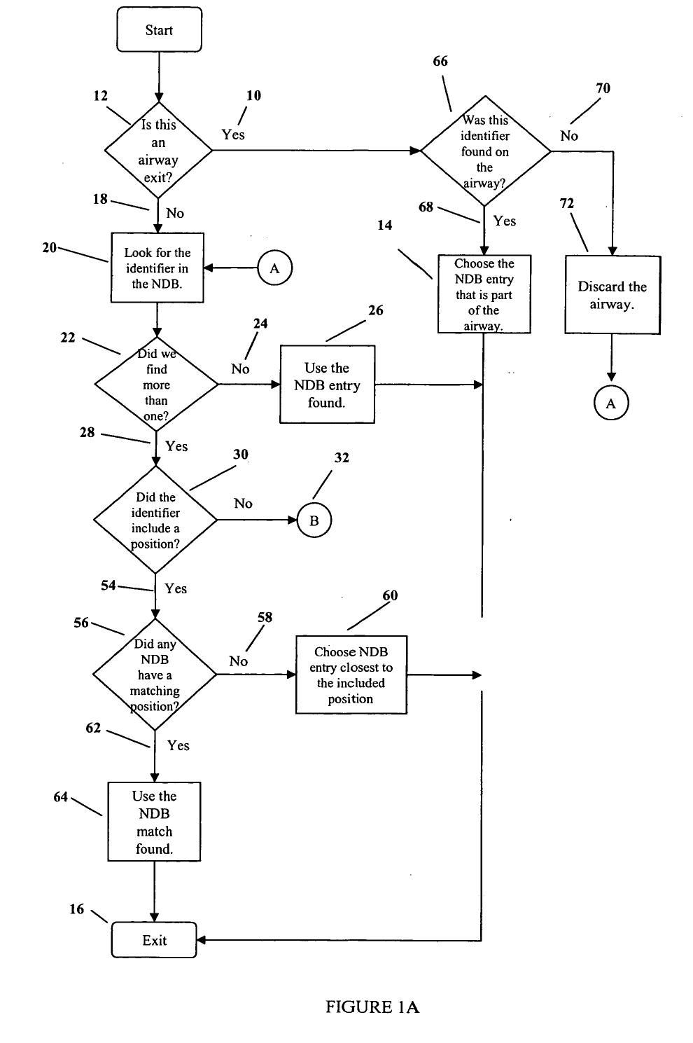

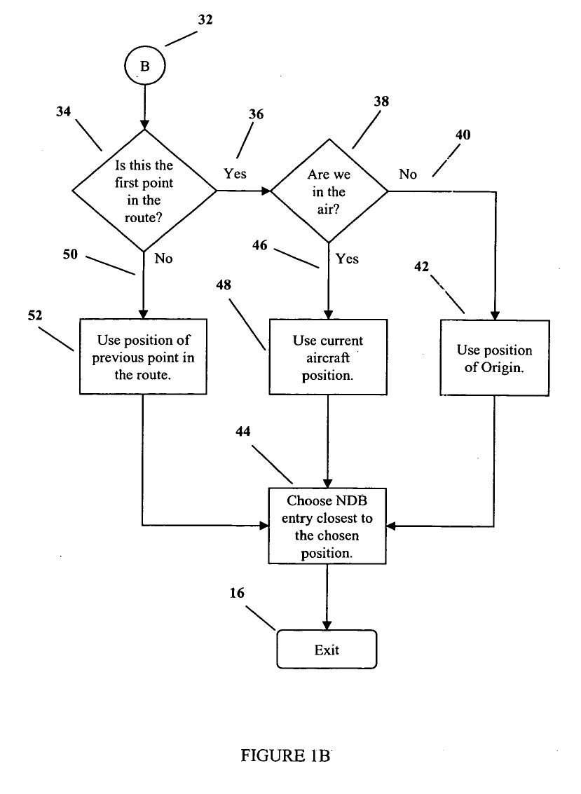

When ambiguous route information items (waypoints) are encountered while processing a route uplink, the preferred system shall select the item that matches the route in accordance with an algorithm, thus discarding those items that cannot be resolved. The preferred system is shown in FIG. 1.

If the route information item is affirmatively 10 an airway exit 12, check to see if that identifier is part of the airway 66. If the identifier is affirmatively part of the airway 68, use the candidate that is part of the airway 14. The system then exits the program 16. If the route information item is following and airway 12 and is not on that airway 70 then discard the airway 72 and continue 20.

If the route information is not 18 an airway exit 12, the next step is to look for an identifier in the NBD 20. If more than one identifier 22 is not found 24, the system uses the NBD entry that is found 26, and the systems exits 16.

If more than one identifier 22 is affirmatively found 28, a check is made to see if the identifier included a latitude/longitude position 30. If a position was included 54 then that position is matched against the entries in the NDB 56. If a match is found 62, that entry is used 64 and the system exits 16. If no match was found in the NDB 58, the NDB entry closest to the supplied position is used 60 and the system exits 16.

If no position was supplied with the identifier 32, a determination is made whether the identifier is the first point in the route 34. If it is affirmatively determined that the identifier is the first point in the route 36, a determination is made whether the aircraft is airborne 38. If a determination is made that the aircraft is not in the air 40 and if the route information item is the first item 34, the system chooses the candidate that is closest to the departure airport or the position of origin 42. The system then chooses the NDB closest to the chosen position 44, which in this case would be the position of origin 42 and the system then exits 16 the program.

If the route information item is the first point in the route 34 and the aircraft is in the air 46, the system chooses the candidate that is closest to the aircraft's current position 48. The system then chooses the NDB closest to the chosen position 44, which in this case would be the current position 48 and the system then exits 16 the program.

If the route information is not the first point in the route 50, for example each subsequent route information item that does not include an optional latitude/longitude, the system chooses the candidate that is closest to the previous route information item 52. The system then chooses the NDB closest to the chosen position 44, which in this case would be the previous route position 52 and the system then exits 16 the program.

By using the system as described above, erroneous selections based on subjective inputs can be minimized. The present invention can be used in any flight plan construction action using any computer platform.

### INDUSTRIAL APPLICABILITY

The invention is further illustrated by the following non-limiting examples.

### EXAMPLE 1

An example of an identifier that has multiple entries in the NDB is identifier LA. The identifier LA presently has 20 NDB entries, positioned around the world. Three of these are in the United States. By using the present invention, if the airplane is on the ground at KORD (Chicago O'Hare), then the LA at N 40° 25.6″ W 87° 3.1″ will be chosen. If the airplane is on the ground at KMKE (Milwaukee, General Mitchell International), then the LA at N 42° 46.7″ W 84° 29.9″ will be chosen. If the airplane is on the ground at KMIA (Miami International), then the LA at N 27° 56.1″ W 82° 4.5″ will be chosen.

### EXAMPLE 2

Another example of an identifier that has multiple identifier entries in the NDB is SP. SP presently has 28 NDB entries, positioned around the world. Two of these are in the United States. By using the present invention, if the airplane is in the air and close to KORD, then the SP at N 39° 46.39″ W 89° 45.59″ will be chosen. If the airplane is in the air and close to KSEA (Seattle-Tacoma International), then the SP at N 33° 54.64″ W 98° 27.27″ will be chosen.

### EXAMPLE 3

Yet another example of an identifier that is part of an airway is the identifier FMN. FMN has two NDB entries. One is a NAVAID, the other an airport identifier (Farmington, N. Mex.). By using the present invention, if a flight plan includes airway J15 from ABQ (Albuquerque, N. Mex.), and FMN is used as an exit from J15, then the NAVAID entry of FMN will be used, because that is the NDB entity that is part of airway J15.

### EXAMPLE 4

Another example of an identifier that has multiple entries in the NDB is CANAL. CANAL presently has 5 NDB entries, positioned around the world. By using the preset invention, if a flight plan exists and includes the airway from FMN to UNG, and then CANAL is added to the route after UNG, the CANAL at N 22° 40.1″ W 82° 14.1″ will be chosen. If CANAL was added to the flight plan directly after FMN, the CANAL at N 42° 40.1″ W 70° 1.4″ will be chosen.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. A method for automatically selecting a waypoint for a flight plan for an aircraft from at least two similarly identified waypoints, the method comprising the steps of:
a) determining a distance to each of the waypoints from the at least two waypoints from a chosen position;
b) determining a condition of the aircraft;
c) providing the flight plan; and
d) calculating the selected waypoint based on steps a), b) and c).

2. The method of claim 1 wherein the step for determining a distance comprises determining which of the each waypoints is closest to the chosen position.

3. The method of claim 1 where in the step of determining a condition of the aircraft comprises determining whether the aircraft in on the ground.

4. The method of claim 1 wherein the step of determining a condition of the aircraft comprises determining whether the aircraft is in the air.

5. The method of claim 1 where in the step of providing the flight plan comprises providing data comprising other waypoints.

6. The method of claim 5 wherein the other waypoints comprise at least one previous waypoint.

7. The method of claim 6 wherein the at least one previous waypoint comprises an airway.

8. The method of claim 1 wherein the chosen position comprises a predetermined position on the flight plan.

9. An apparatus for automatically selecting a waypoint for a flight plan for an aircraft from at least two similarly identified waypoints, the apparatus comprising:
a means for measuring a distance to each of the waypoints from the at least two waypoints from a chosen position;
a storage means for storing measured distances in the means for measuring, a condition of the aircraft and the flight plan; and
a means for calculating the selected waypoint based on data in the storage means.
